(19) United States
(12) Patent Application Publication
(10) Pub. No.: US 2022/0269300 A1
(43) Pub. Date: Aug. 25, 2022

(54) MULTI-AXIS GIMBAL AND CONTROLLER COMPRISING SAME

(71) Applicant: Fluidity Technologies Inc., Houston, TX (US)

(72) Inventors: Scott Edward PARAZYNSKI, Houston, TX (US); Wayne JOHNSON, Spokane, WA (US); Stuart RUSH, Spring, TX (US)

(21) Appl. No.: 17/679,471

(22) Filed: Feb. 24, 2022

Related U.S. Application Data
(63) Continuation of application No. PCT/US2022/016963, filed on Feb. 18, 2022.
(60) Provisional application No. 63/153,615, filed on Feb. 25, 2021.

(51) Int. Cl. G05G 9/047; G05G 5/05; G05G 5/03

(52) U.S. Cl. CPC G05G 9/04785; G05G 5/05; G05G 5/03; G05G 2009/04718; G05G 2009/04744; G05G 2009/04766; G05G 2009/04748

(57) ABSTRACT

The present disclosure relates generally to control systems, and in particular apparatus, methods, and systems for controlling flights remotely or onboard the vehicle. More specifically, the present disclosure describes embodiments of a control system that allows a user to control the motion of a target in or along one or more degrees of freedom using a single controller. The control system described herein also include mechanisms that permit the conversion of user intent into discrete 3-D motions with tactile feedback relative to the null command.

### RELATED APPLICATIONS

This application is a continuation of International PCT Application No. PCT/US2022/016963, filed on Feb. 18, 2022, which claims priority to and the benefit of U.S. Provisional Patent Application No. 63/153,615, filed on Feb. 25, 2021, the disclosure of each of which is hereby incorporated by reference in its entirety.

### FIELD OF THE INVENTION

The present disclosure relates generally to control systems, and in particular apparatus, methods, and systems for controlling a target in real life or in a virtual environment, e.g., flights of Unmanned Aerial Systems (UAS) as well as onboard-piloted aircraft, a remotely operated vehicle (ROV), a crewed aerial vehicle with distributed electric propulsion, a crewed submersible, a spacecraft, a surgical robotic device, an industrial robotic, a scissor lift, a fork lift, a crane, or an earth mover. The apparatus and systems can include a gimbal assembly that permits movement of a controller through multiple degrees of freedom and a zero-input position for each degree of freedom.

### BACKGROUND

Input devices or controllers, such as joysticks, control columns, cyclic sticks, and foot pedals generate control inputs for a real or virtual target by sensing movement of one or more control members by a person that is commanding or controlling movement and operation of the target. These types of controllers have been used to control inputs for parameters such as pitch, yaw, and roll of the target, as well as navigational parameters such as translation (e.g., x-, y-, and z-axis movement) in a three-dimensional (3D) space, velocity, acceleration, and/or a variety of other command parameters. Examples of targets that can be controlled include an aircraft, submersible vehicles, spacecraft, industrial cranes, robotic surgical instruments, a control target in a virtual environment such as a computer game or virtual or augmented reality environments, and/or a variety of other control targets as may be known by those of ordinary skill in the art.

### SUMMARY

When operating a drone (or UAS), for example, the zero input positions of the controller that control the drone along the x, y, and z axes and to yaw (rotation about the z axis) should be always known. Other flight regimes, such as virtual and augmented reality, computer gaming and surgical robotics may require control inputs for as many as six independent degrees of freedom simultaneously: translation along x, y, and z axes, and pitch, yaw, and roll (rotation about the three axes). Knowing the location of the “zero input” for each degree of freedom (DoF) of the control member or controller independently and at the same time for a controller that moves a point of reference (POR) through physical or virtual space allows for more intuitive control.

The present disclosure provides a gimbal assembly and a controller that permit a user to always know the zero input positions of the controller and control a target in or along one or more DoF. The gimbal assembly can also inform a user who is manually manipulating a control member of the controller, with haptic or tactile feedback, of when the control member is in a zero command or null position (one in which there is no control input to the target) in at least one DoF.

One aspect of the present disclosure relates to a gimbal assembly for a control member to independently pivot about a first axis of rotation and a second axis of rotation, the gimbal assembly including: (a) a post having a first end, a second end, and a body therebetween, the post having a null position at a predetermined angular displacement about each axis of rotation; (b) a first biasing member disposed around the body of the post, the first biasing member being configured to generate a first or second biasing force when the post pivots about the first or second axis; and (c) a cage assembly coupled to the first end of the post, the cage assembly including: (c-i) a coupling member; (c-ii) a first cage member having a first surface with an opening, the first surface having a downward slope towards the perimeter of the opening, wherein the coupling member is disposed between the first biasing member and the first cage member and configured to be moved up or down the slope as the post pivots; (c-iii) a second cage member having a first slot elongated along the first axis, pivotal movement of the post about the second axis causing the first end of the post to translate along the first slot; and (c-iv) a third cage member having a second slot elongated along the second axis, pivotal movement of the post about the first axis causing the first end of the post to translate along the second slot, wherein the second cage member is disposed between the first cage member and the third cage member.

Another aspect of the present disclosure relates to a controller for controlling a target, the controller including: (a) a first control member configured to be gripped by a hand of a user; (b) a base; and (c) a gimbal assembly of the present disclosure coupled to the first control member and the base to permit movement of the first control member by the user relative to the base independently about the first axis, the second axis, and the third axis to generate a corresponding set of three independent control inputs, wherein the post of the gimbal assembly is connected to the base at the first end and with the first control member at the second end.

### BRIEF DESCRIPTION OF THE FIGURES

FIG. 1 is a schematic illustration of a gimbal assembly, according to an embodiment.

FIG. 2 is an exploded view of a gimbal assembly, according to an embodiment.

FIG. 3 is a cross-sectional side view illustrating different angles for the slope on the first cage member of the gimbal assembly of FIG. 2.

FIG. 4A is a cross-sectional side view illustrating the gimbal assembly of FIG. 2 when the post is in a first predetermined null position with respect to a first axis of rotation.

FIG. 4B is a cross-sectional side view illustrating the gimbal assembly of FIG. 2 when the post is in a second predetermined null position with respect to a second axis of rotation.

FIG. 4C is a side view illustrating the gimbal assembly of FIG. 2 when the post moves away from the first predetermined null position with respect to the first axis of rotation.

FIG. 4D is a cross-sectional side view of the gimbal assembly of FIG. 4C.

FIG. 4E is a side view illustrating the gimbal assembly of FIG. 2 when the post moves away from the second predetermined null position with respect to the second axis of rotation.

FIG. 4F is a cross-sectional side view of the gimbal assembly 200 of FIG. 4E.

FIGS. 5A to 5C are rear perspective, top, and rear elevation views, respectively, of a controller, according to an embodiment.

FIG. 5D is a cross-sectional side view of the controller of FIGS. 5A to 5C, taken along line 5D-5D of FIG. 5C, according to an embodiment.

FIG. 6 is a cross-sectional top elevation view of the controller of FIG. 5B, according to an embodiment.

FIG. 7 is a flow diagram illustrating the signal flow when a user operates the controller of FIGS. 5A to 5C, in one example DoF.

### DETAILED DESCRIPTION

The present disclosure describes embodiments of a control system that allows a user to control the motion of a control target in or along one or more DoF using a single controller. For example, a unified hand controller may allow a user to control the motion of a target in one or more DoF, the one or more DoF including three rotational DoFs (e.g., pitch, yaw, and roll) and three translational DoFs (e.g., movements along x, y, and z axes). For instance, a unified hand controller may allow a user to control the motion of a target in three rotational DoFs (e.g., pitch, yaw, and roll) and one translational DoF (e.g., movements along z axis). The control system may also be configured to allow a user to control the movements of a control target in real settings or virtual settings, such as but not limited to gaming environments. In some embodiments, the control system may also allow a user to receive feedback from the control target based on sensory inputs or measurements procured by the control target, whether in real or virtual environments.

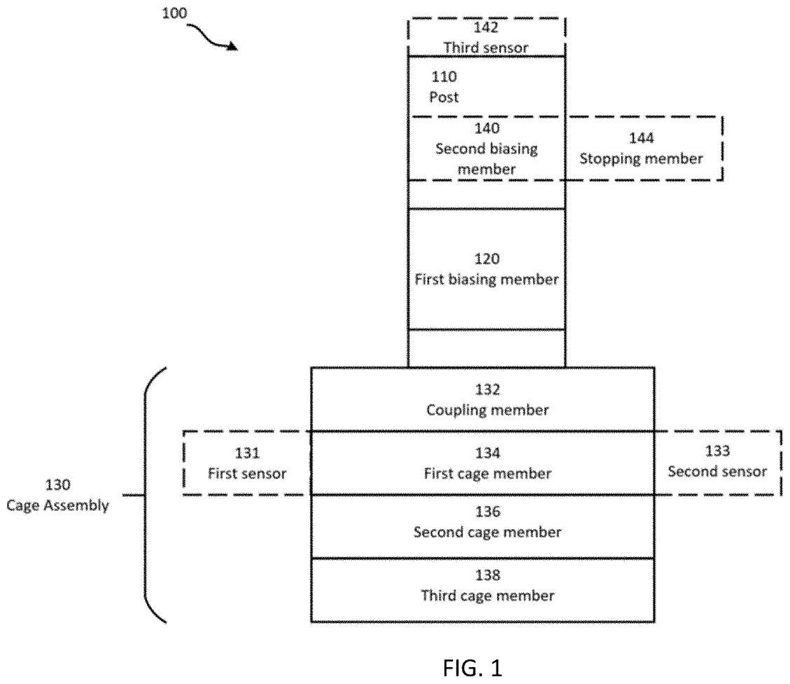

The controller includes a gimbal assembly that allows a user to control the motion of a target in one or more DoFs, as described above. As shown in FIG. 1, the gimbal assembly 100 can include a post 110, a first biasing member 120, and a cage assembly 130.

The post 110 has a first end, a second end, and a body therebetween. The post 110 can rotate about a first axis of rotation and a second axis of rotation. The post 110 can have a first null position at a predetermined angular displacement about the first axis of rotation. The post 110 can have a second null position at a predetermined angular displacement about the second axis of rotation. A control member (not shown; not part of the gimbal assembly but part of the controller) that is coupled to the post 110 can rotate about a third axis of rotation and have a third null position at a predetermined angular displacement about the third axis of rotation. For a motion about the third axis of rotation, the post 110 remains stationary while the control member rotates around the post 110. In some embodiments, the first axis, the second axis, and the third axis of rotation are orthogonal to each other. For example, the first axis, the second axis, and the third axis of rotation can represent, or correspond to, a pitch axis, a roll axis, and a yaw axis, respectively, for a control target. Accordingly, the third axis of rotation can be parallel to a line joining the first end and the second end of the post 110.

The post 110 is an elongated member. In some embodiments, the post 110 is a shaft. In some embodiments, at least a portion of the post 110 has a cylindrical shape.

The first biasing member 120 can be disposed around the body of the post 110. In some embodiments, the first biasing member 120 can be a spring (e.g., a coil spring). In some embodiments, the first biasing member 120 can be a coil spring (which may be under compression when the post 110 is in a neutral position). Alternatively, the first biasing member 120 can be a counterbalanced pair of springs. In some embodiments, the counterbalanced pair of springs can be adjustable, such that the preload of the springs can be dialed up or down. Yet alternatively, the first biasing member 120 can be an active force feedback system (e.g., an electromechanical system), wherein the system is configured to impart feedback to the user through the post 110. The first biasing member 120 can be configured to generate a first biasing force when the post 110 pivots about the first axis of rotation. Alternatively or additionally, the first biasing member 120 can be configured to generate a second biasing force when the post 110 pivots about the second axis of rotation. As discussed in more detail below, when the post 110 pivots about the first axis of rotation, it generates a first input to be received by a target; and when the post 110 pivots about the second axis of rotation, it independently generates a second input to be received by the target.

The cage assembly 130 can be coupled to the first end of the post 110. In some embodiments, the cage assembly 130 can include a coupling member 132, a first cage member 134, a second cage member 136, and a third cage member 138. The coupling member 132 can be disposed between the first biasing member 120 and the first cage member 134. The first cage member 134 can be disposed between the coupling member 132 and the second cage member 136. The second cage member 136 can be disposed between the first cage member 134 and the third cage member 138.

Each of the coupling member 132, the first cage member 134, the second cage member 136, and the third cage member 138 has an opening, such that when they are assembled together to form the cage assembly 130, the first end of the post 110 can pass through the coupling member 132, the first cage member 134, the second cage member 136, and the third cage member 138 altogether through the openings. In some embodiments, the first cage member 134, the second cage member 136, and the third cage member 138 can include features/mechanisms for them to be snap-fitted to each other.

In some embodiments, the gimbal assembly 100 can further include a second biasing member 140. The second biasing member 140 can be disposed around the second end of the post 110. In some embodiments, the second biasing member 140 can be a spring (e.g., a torsion coil spring). In some embodiments, the second biasing member 140 can be a counterbalanced pair of springs. In some embodiments, the counterbalanced pair of springs can be adjustable, such that the preload of the springs can be dialed up or down. Alternatively, the second biasing member 140 can be an active force feedback system (e.g., an electromechanical system), wherein the system is configured to impart feedback to the user through the post 110. The second biasing member 140 can be configured to generate a third biasing force when the control member that is coupled to the post 110 rotates about the third axis of rotation. As discussed in more detail below, when the control member that is coupled to the post 110 rotates about the third axis of rotation, it independently generates a third input to be received by the target.

In some embodiments, to control the range of rotation by the control member that is coupled to the post 110 about the third axis of rotation, a stopping member 144 is disposed on an interior of the control member. The stopping member 144 can serve as a mechanical stop to prevent the control member from rotating more than a certain number of degrees about the third axis of rotation in either direction. For example, the stopping member 144 is configured to prevent the control member from rotating more than about 25 degrees, about 20 degrees, or about 15 degrees about the third axis of rotation in either direction. In some embodiments, the stopping member 144 is configured to prevent the control member from rotating more than about 20 degrees about the third axis of rotation in either direction. The range of rotation may vary based on the needs of the user and the activity being controlled.

In some embodiments, the gimbal assembly 100 can further include one or more sensors configured to detect user inputs to the post 110. For example, sensors(s) can measure angular movement of the post 110, and/or application of force to the post 110, in one or more of the available DoFs. The sensor can be a potentiometer, a Hall effect sensor, an optical encoder, a load cell, or any other device that can measure angular movement. In some embodiments, the gimbal assembly 100 can include at least three sensors, each of which can be used to measure the angular movement of the post 110 about the first and second axes of rotation, and the control member about the third axis of rotation, respectively. In some embodiments, a first sensor 131 can be disposed on a first side (e.g., a first flange) of the first cage member 134, thereby permitting the first sensor 131 to measure the pivotal movement of the post 110 about the first axis of rotation. In some embodiments, a second sensor 133 can be disposed on a second side (e.g., a second flange) of the first cage member 134, thereby permitting the second sensor 133 to measure the pivotal movement of the post 110 about the second axis of rotation. In some embodiments, a third sensor 142 can be disposed on the second end of the post 110 to measure the rotation of the control member about the third axis of rotation.

Advantageously, in some embodiments the gimbal assembly can include parts that can be snap-fitted together, thereby simplifying assembly. For example, no ultrasonic welding, heat staking or adhesive may be needed for assembling the gimbal assembly.

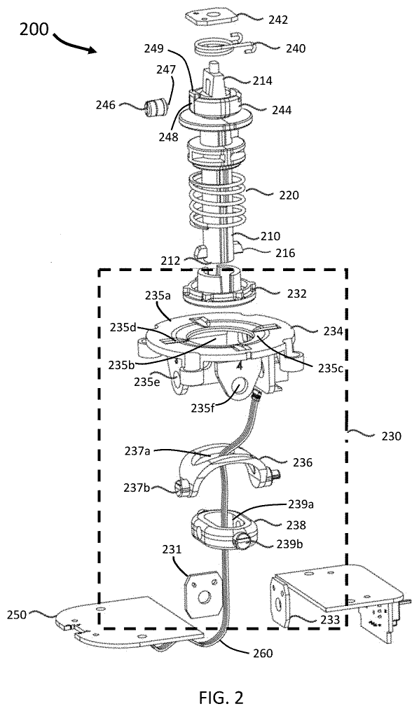

FIG. 2 provides an exploded view illustrating a gimbal assembly according to one embodiment implementing the structures and functions described above for gimbal assembly 100 of FIG. 1. As illustrated in FIG. 2, the gimbal assembly 200 includes a post 210, a first biasing member 220, and a cage assembly 230. The cage assembly 230 includes a coupling member 232, a first cage member 234, a second cage member 236, and a third cage member 238.

The post 210 includes a first end 212 and a second end 214. Depending on the final configuration, the first end 212 can be the lower end, while the second end 214 can be the upper end. The post 210 further includes an elongated body extending from the first end 212 to the second end 214. The post 210 further includes one or more protrusions 216 disposed on the first end 212. In some embodiments, the post 210 includes two protrusions 216 that are diametrically opposed to each other. The protrusions 216 are configured to permit the post 210 to be locked into position with respect to the cage assembly 230. More specifically, after the post 210 is inserted into the cage assembly 230 to assemble the gimbal assembly 200, the post 210 is rotated (i.e., into the orientation shown in FIG. 2) so that the protrusions 216 prevent the post 210 from sliding out of the cage assembly 230.

The first biasing member 220, disposed around the body of the post 210, can extend for a certain length along the body. The first biasing member 220 is characterized by a sufficient spring constant such that when a user pivots the post 210 about the first axis or second axis of rotation, it generates a sufficient biasing force to bring the post 210 back to a null position when the user releases the post 210. As such, the biasing force provides a re-centering mechanism. In some embodiments, the spring constant is about 6 lbf/in to about 14 lbf/in, e.g., about 8 lbf/in to about 12 lbf/in. In some embodiments, the first biasing member 220 is preloaded with a torque.

The second biasing member 240, disposed around the second end 214 of the post 210, is configured to generate an input independent of the first biasing member 220. The second biasing member 240 is characterized by a sufficient spring constant such that when a user rotates the control member that is coupled to the post 210 about the third axis of rotation, the second biasing member 240 is rotated, thereby generating a torque on the second biasing member 240. As a result, when the user releases the control member, the second biasing member 240 generates a sufficient biasing force to bring the control member back to a null position. As such, the biasing force provides a re-centering mechanism. In some embodiments, the spring constant is about 0.01 in-lbs/deg to about 0.04 in-lbs/deg, e.g., about 0.02 in-lbs/deg to about 0.03 in-lbs/deg. In some embodiments, the second biasing member 240 is preloaded with a torque.

The gimbal assembly 200 can further include a second coupling member 244 and a detent 246. The second coupling member 244 encloses the second biasing member 240. The detent 246 is disposed on an interior surface of the control member that is coupled to the post 210. In some embodiments, the detent 246 is a spring plunger that includes a ball 247 configured to engage a surface feature 248 of the second coupling member 244, thereby indicating a null position with respect to the third axis of rotation. In some embodiments, the surface feature 248 is a dimple, a divot, or a recess. When the detent 246 rotates together with the control member, the ball 247 disengages the surface feature 248 (the ball 247 is pushed in as a result), and upon the detent 246 returning to the null position, reengages the surface feature 248 (the ball 247 extends as a result), thereby providing haptic feedback that can be felt by the user. The haptic feedback confirms to the user that rotation about the third axis is at the zero or null position without ever having to look at his or her hand or question whether the command input is at zero.

The second coupling member 244 can further include a protrusion 249 configured to engage with a stopping member of the control member that is coupled to the post 210. The stopping member is disposed on an interior surface of the control member. When the control member rotates about the third axis of rotation, after a certain degree of rotation, the stopping member is physically stopped by the protrusion 249, thereby preventing the control member from rotating further.

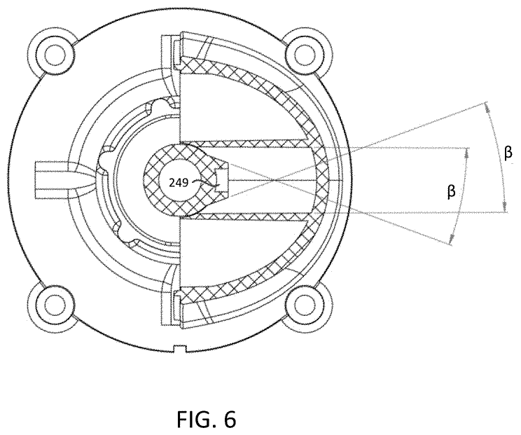

Referring to FIG. 6, the protrusion 249 is shown. The angle 13 indicates the range of rotation of the control member about the third axis of rotation (e.g., yaw) in either direction. In some embodiments, 13 is about 25 degrees, about 24 degrees, about 22 degrees, about 20 degrees, about 18 degrees, about 16 degrees, or about 15 degrees. In some embodiments, 13 is about 20 degrees.

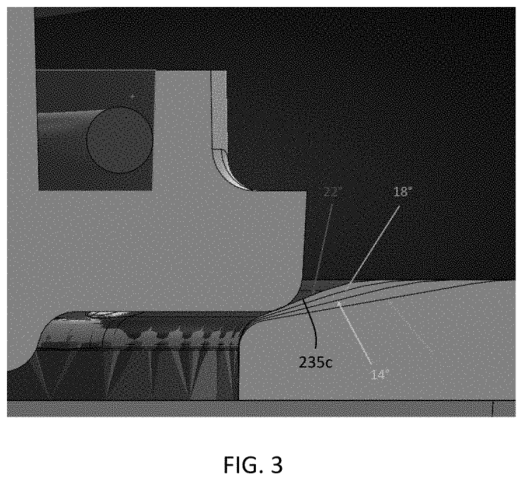

Referring back to FIG. 2, the first cage member 234 in the cage assembly 230 has a first surface 235a with an opening 235b. In some embodiments, the opening 235b is circular. On the first surface 235a, there is a downward slope 235c towards the perimeter of the opening 235b. When the post 210 pivots about the first axis or second axis of rotation, the post 210 moves the coupling member 232 up or down the slope 235c. As the post 210 pivots to move the coupling member 232 up the slope 235c, the first biasing member 220 generates a biasing force to bring the coupling member 232 back down the slope 235c. FIG. 3 is a cross-sectional side view illustrating different angles for the slope 235c on the first cage member 234 of the gimbal assembly 200 of FIG. 2. Specifically, FIG. 3 shows that the angle of the slope 235c is 10°, 14°, 18°, or 22°, according to different embodiments. The selection of the angle can be based in part on a desired preference for user experience, the materials of the coupling member 232 and/or the first cage member 234, and the lubricity of the materials.

The steepness of the slope 235c has an effect on the tactile feel of the post 210 moving in and out of a null position. In some embodiments, the slope 235c can have an angle such that the tactile feel is smooth. In some embodiments, the slope 235c can have an angle of at least about 5 degrees, at least about 6 degrees, at least about 7 degrees, at least about 8 degrees, at least about 9 degrees, or at least about 10 degrees. In some embodiments, the slope 235c can have a degree of no more than about 15 degrees, no more than about 14 degrees, no more than about 13 degrees, no more than about 12 degrees, or no more than about 11 degrees.

Referring back to FIG. 2, the first cage member 234 optionally includes one or more surface features 235d on the first surface 235a. For example, the first cage member 234 can include one, two, three, four, or more surface features 235d. In some embodiments, the first cage member 234 can include two surface features 235d colinear with each other. In some embodiments, the first cage member 234 can include two pairs of surface features 235d, each pair having two surface features 235d in a colinear relationship. The surface feature 235d can be recessed into the first surface 235a, e.g., formed as a slot, or can protrude from the first surface 235a, e.g., formed as a ridge. Through an interaction between the surface feature 235d and the coupling member 232, the surface feature 235d is configured to provide tactile feedback when the post 210 leaves a null position with respect to the first axis or second axis of rotation and rotates about the third axis of rotation. The tactile feedback permits a user to feel the presence of the surface feature 235d and may therefore enhance user experience. In some embodiments where the surface feature 235d is a divot, the divot can function similarly as a reverse speed bump for the coupling member 232, thereby permitting the user to feel resistance when moving the coupling member 232 over the surface feature 235d. In some embodiments, the surface feature 235d and the coupling member 232 provide a user with simultaneous and independent feedback on relative displacement from the null position in two dimensions (e.g., pitch and roll).

Absent a force applied by a user, the coupling member 232 rests on top of the opening 235b and is disposed between the first biasing member 220 and the first cage member 234. In some embodiments, the coupling member 232 has a circular circumference.

The second cage member 236, disposed between the first cage member 234 and the third cage member 238, includes a first slot 237a elongated along the first axis of rotation. The second cage member 236 can have a curved shape such that it can be disposed around the third cage member 238 in a compact manner. The second cage member 236 includes a pair of protrusions 237b which can be snap-fitted into the openings 235e of the first cage member 234.

The third cage member 238 includes a second slot 239a elongated along the second axis of rotation. The third cage member 238 includes a pair of protrusions 239b which can be snap-fitted into the openings 235f of the first cage member 234.

To assemble the gimbal assembly 200, the protrusions 216 are oriented to pass through a vertical slot in the coupling member 232, then rotated to pass through the first slot 237a, and then rotated again to pass through the second slot 239a. As a result, the protrusions 216 lock the post 210 into position with respect to the cage assembly 230.

In some embodiments, the moving parts of the gimbal assembly 200 are alternated between nylon and acetal, thereby reducing “squeaking” or other noise produced by relative movement of the parts and avoiding the need for grease or other lubricant. Thus, for example, the third cage member 238 can be formed of nylon, and the first cage member 234 can be formed of acetal, so that there are different materials at the interface between the protrusions 239b and the openings 235f.

When the post 210 pivots about the second axis of rotation, it causes the first end 212 to: (a) translate along the first slot 237a (the second cage member 236 remains stationary as a result), and (b) rotate the third cage member 238.

Similarly, when the post 210 pivots about the first axis of rotation, it causes the first end 212 to: (a) translate along the second slot 239a (the third cage member 238 remains stationary as a result), and (b) rotate the second cage member 236.

When the control member that is coupled to the post 210 rotates about the third axis of rotation, the post 210, the second cage member 236, and the third cage member 238 remain stationary.

The angular movement of the post 210 about the first or second axis of rotation can be measured by a sensor. In some embodiments, the gimbal assembly 200 includes a first sensor 231 coupled to the third cage member 238 and configured to measure the rotation of the third cage member 238, which is correlated to the pivotal movement of the post 210 about the second axis of rotation. In some embodiments, the gimbal assembly 200 includes a second sensor 233 coupled to the second cage member 236 and configured to measure the rotation of the second cage member 236, which is correlated to the pivotal movement of the post 210 about the first axis of rotation.

In some embodiments, the gimbal assembly 200 includes a third sensor 242 disposed on the second end 214 and configured to measure the rotation of the control member about the third axis of rotation.

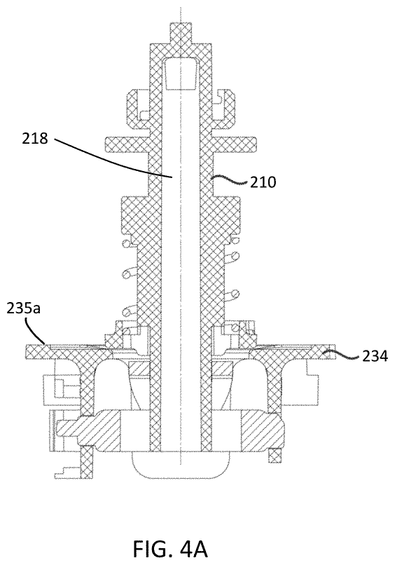

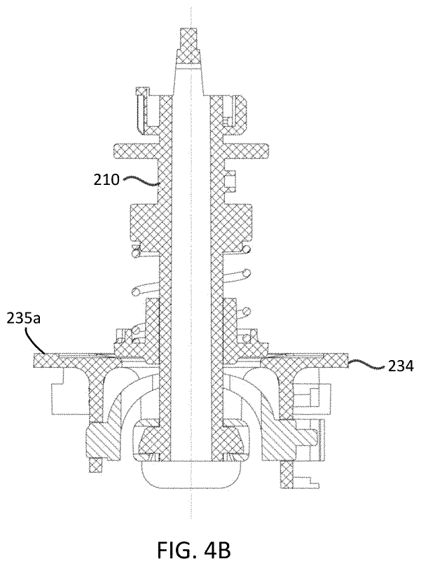

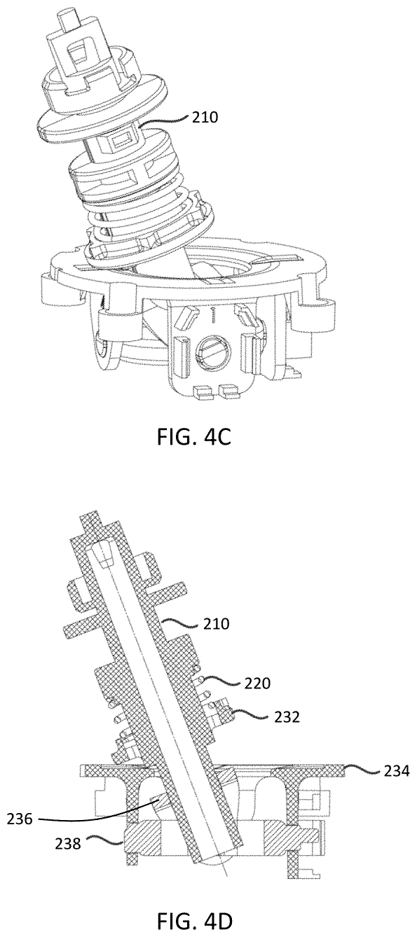

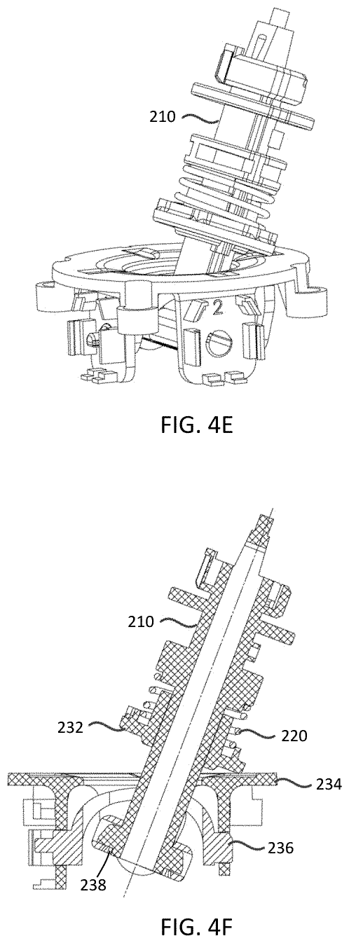

Each of the sensors can be electrically coupled to a printed circuit board (PCB) 250. The PCB can be electrically coupled to a conductor cable assembly 260. In some embodiments, the post 210 includes a central bore 218 extending through the body of the post 210 (see FIG. 4A). The conductor cable assembly 260 can thus pass through the bore 218. The conductor cable assembly 260 is configured to transmit information from the first, second, and/or third sensor to a processor, which can be disposed on the PCB 250.

FIGS. 4A and 4B are cross-sectional side views taken along orthogonal planes, illustrating the gimbal assembly 200 of FIG. 2 when the post 210 is disposed in a null position with respect to the first surface 235a of the first cage member 234, about both the first axis of rotation (in FIG. 4A) and the second axis of rotation (in FIG. 4B).

FIG. 4C is a side perspective view illustrating the gimbal assembly 200 of FIG. 2 when the post 210 is displaced away from the null position about the first axis of rotation, and FIG. 4D is a cross-sectional side view of the gimbal assembly 200 of FIG. 4B. As a user moves the post 210 away from the null position by pivoting the post 210 about the first axis of rotation, the coupling member 232 is moved up the slope on the first cage member 234 by the post 210, the second cage member 236 is rotated by the post 210, while the third cage member 238 remains stationary. In addition, due to its distortion, the first biasing member 220 generates a first biasing force, which urges the post 210 back towards the first predetermined null position, and restores it to the null position if the user does not apply any force to post 210. The first biasing force also provides haptic feedback when the post 210 leaves and returns to the first predetermined null position.

FIG. 4E is a side view illustrating the gimbal assembly 200 of FIG. 2 when the post 210 is displaced away from the null position, pivoted about the second axis of rotation, and FIG. 4F is a cross-sectional side view of the gimbal assembly 200 of FIG. 4E. As a user moves the post 210 away from the null position by pivoting the post 210 about the second axis of rotation, the coupling member 232 is moved up the slope on the first cage member 234 by the post 210, the third cage member 238 is rotated by the post 210, while the second cage member 236 remains stationary. In addition, due to its distortion, the first biasing member 220 generates a second biasing force, which urges the post 210 back towards the second predetermined null position, and restores it to the null position if the user does not apply any force to the post 210. The second biasing force also provides haptic feedback when the post 210 leaves and returns to the second predetermined null position.

The gimbal assembly of the present disclosure can be included in a controller for onboard or remote control of a target. In some embodiments, the target is a fixed-wing aircraft, an electric, hybrid, and/or combustion powered aircraft, a remotely operated vehicle (ROV), a crewed aerial vehicle with distributed electric propulsion, a crewed submersible, a spacecraft, a surgical robotic device, or a virtual craft or virtual environment such as computer gaming. Additionally, such a controller could be used in industrial robotics, to include robotic arms, scissor lifts, fork lifts, cranes and earth movers.

The gimbal assembly described herein provides a re-centering mechanism for a control member of the controller in at least one DoF in one embodiment, at least two DoFs in another embodiment, and at least three DoFs in yet another embodiment, to give the user a sense of “zero” or null command. In some embodiments, when the control member is displaced along one of the DoFs, the gimbal assembly generates a tactile feedback, such as a mechanical force (generated, for example, by a spring or a detent), a shake, a change in speed, or another type of haptic signal, on the control member to return them to a position for zero input (i.e., the zero or null position).

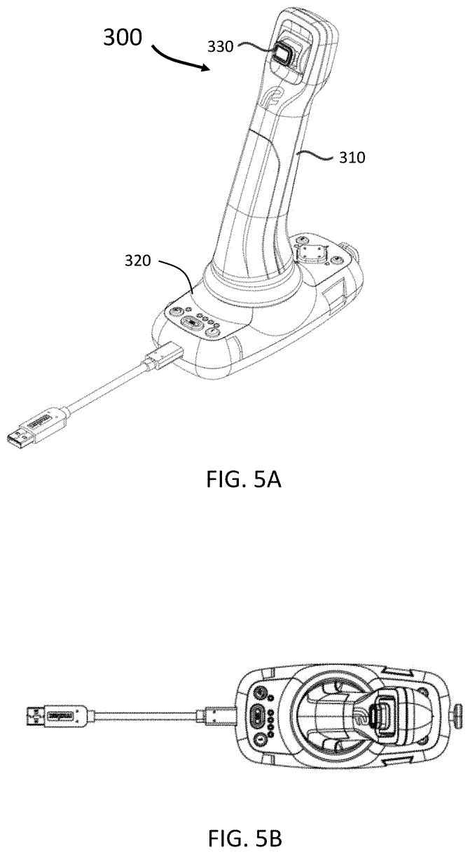

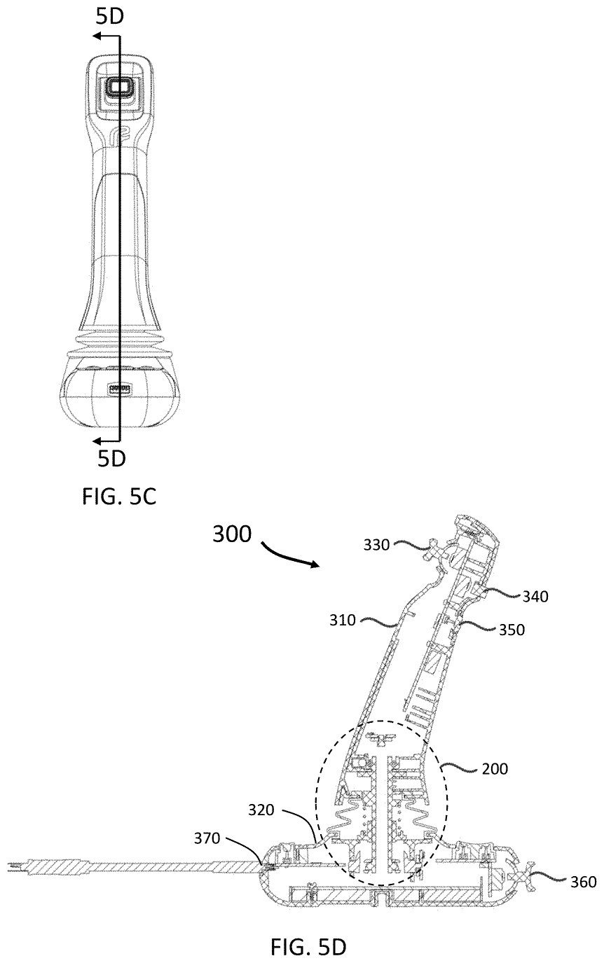

An embodiment of controller 300 for controlling a target, and that incorporates a gimbal, such as gimbal 200 described above, is shown in FIGS. 5A to 5D. Controller 300 includes a first control member 310 configured to be gripped by a hand of a user and a base 320. The first control member 310 is coupled to the base 320 by a gimbal 200. In some embodiments, the first control member 310 is in the form of a joystick. In some embodiments, the base 320 is configured to be manipulated by the user, e.g., to be gripped by a hand of the user. In some embodiments, the base 320 may be mounted on a surface, a tripod or body-worn via a waist harness or torso harness.

As shown in the cross-sectional view in FIG. 5D, the gimbal assembly 200 is coupled to the first control member 310 and the base 320 to permit movement of the first control member 310 by the user relative to the base 320 independently about a first axis, a second axis, and a third axis of rotation to generate a corresponding set of three independent control inputs. The post of the gimbal assembly 200 is connected to the base 320 at the first end and with the first control member 310 at the second end.

Since the first control member 310 is coupled to the post of the gimbal assembly 200, the movement of the first control member 310 about each axis of rotation is translated to the corresponding movement of the post about the same axis of rotation, thereby generating independent control inputs. In some embodiments, the set of three independent control inputs includes a pitch movement signal, a roll movement signal, and a yaw movement signal. For the yaw movement, the post of the gimbal assembly 200 remains stationary while the first control member 310 rotates around the post. In some embodiments, the first control member 310 may be spring-centered and configured to be pushed down and pulled up by a user relative to the base 320 to control vertical movement of the target.

The controller 300 can further include a second control member 330 disposed on the first control member 310. In some embodiments, the second control member 330 is disposed in a position in which it is capable of being displaced with a thumb or another digit of the same hand that is gripping the first control member 310. In some embodiments, the second control member 330 can be in the form of a wheel or a button. The second control member 330 can provide control in one or more DoF (e.g., one, two, three, or more DoFs) independent of those controlled by the first control member 310. Features on a second control member with one or more DoF can be found in U.S. Pat. Nos. 9,547,380, 10,324,540, and 10,481,704, the contents of each of which are incorporated herein by reference in their entirety. In the illustrated embodiment, the second control member 330 is configured to rotate up and down in a single DoF relative to the first control member 310 to provide in response thereto a corresponding fourth control input. In some embodiments, the fourth control input is configured to control vertical movement of the target. In some embodiments, the fourth control input is configured to control forward and reverse velocity of the target.

Additionally or alternatively, the second control member 330 may be spring-centered and configured to be pushed down and pulled up by a user in a single DoF relative to the first control member 310 to provide in response thereto a corresponding fifth control input. In some embodiments, the fifth control input is configured to control vertical movement of the target. In some embodiments, the fifth control input is configured to control forward and reverse velocity of the target.

In some embodiments, the second control member 330 is coupled to a detent configured to define a fourth predetermined null position, the fourth null position being hovering.

The controller 300 can further include one or more additional control members configured to control a device (e.g., a camera or a sensor) on the target. In some embodiments, the controller 300 can further include a third control member 340 and/or a fourth control member 350 disposed on the first control member 310 and configured to control a camera of the target. In some embodiments, the controller 300 can further include a fifth control member 360 disposed on the base 320 and configured to control a camera of the target. Controlling the camera includes, but is not limited to, opening or closing a shutter of the camera, zooming in or out, starting or stopping photo taking, starting or stopping video taking, tilting the camera, or combination thereof. For example, the third control member 340 can be in the form of a wheel and configured to control the camera zoom. The fourth control member 350 can be in the form of a button and configured to open or close a shutter of the camera. The fifth control member 360 can be in the form of a wheel and configured to tilt the camera by rotating up and down. Features for controlling a camera or sensor can be found in U.S. Pat. No. 10,331,233, the contents of which are incorporated herein by reference in their entirety.

The controller 300 can further include one or more control members configured to control a thrust component of the target.

In some embodiments where the target includes a plurality of engines, the controller 300 can further include a plurality of control members, each control member being configured to control an engine of the target. Features for controlling a target with a plurality of engines can be found in U.S. application Ser. No. 17/110,576, the contents of which are incorporated herein by reference in their entirety.

The controller 300 can further include a display mounted on one of the control members for displaying to the user situational awareness information about the target. Features for displaying situational awareness information can be found in U.S. Pat. No. 10,331,232, the contents of which are incorporated herein by reference in their entirety.

The controller 300 can further include a processor configured to receive from a sensor, in a wired or wireless manner, a measured amount of displacement of the first control member 330 about the first axis, the second axis, or the third axis of rotation. In some embodiments, to receive from the sensor, the processor is coupled to the conductor cable assembly 260 shown in FIG. 2.

The controller 300 can further include a port 370 for wired connection to an external device (laptop, smart device, tablet, monitor, projector, heads-up display, and/or computer simulator) or a power source.

In some embodiments, during operation, a user can hold onto the base 320 with one hand and control the movement of the first control member 310 with the other hand. In addition, the user can: (a) control the movement of the second control member 330 with the thumb of the other hand; and/or (b) control the movement of the third control member 340 and/or the fourth control member 350 with the index figure of the other hand.

In some embodiments, during operation, the controller 300 can be fixed to a stationary surface, tripod or body harness, and the user can: (a) control the movement of the first control member 310 with the dominant hand; (b) control the movement of the second control member 330 with the thumb of the dominant hand; and/or (c) control the movement of the third control member 340 and/or the fourth control member 350 with the index figure of the dominant hand.

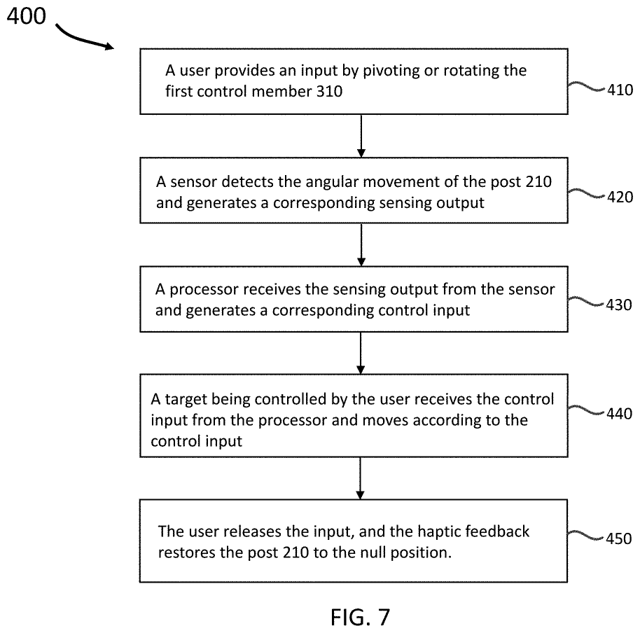

FIG. 7 is a schematic diagram illustrating the signal flow when a user operates the controller 300 of FIG. 5A in one example DoF. In step 410, a user provides an input by pivoting or rotating the first control member 310. As a result, the first control member 310 pivots or rotates the post 210 in the gimbal assembly. In step 420, a sensor detects the angular movement of the post 210 and generates a corresponding sensing output. In step 430, a processor receives the sensing output in a wired or wireless manner from the sensor, and then generates a corresponding control input. In step 440, the target that is controlled by the user receives the control input from the processor and moves according to the control input. After step 410, in parallel with steps 420-440, the user receives haptic feedback indicating that a command is being triggered, and tactile feedback indicating that the controller 300 is out of the null position. In step 450, the user releases the input, and the haptic feedback restores the post 210 to the null position.

In some embodiments, the controller described herein can be used to control a drone, e.g., a camera drone (i.e., hover mode drone) or a first-person view (FPV) drone. In some embodiments, the controller can be used to control both camera drones and FPV drones. For example, the controller can have a first mode for controlling camera drones and a second mode for controlling FPV drones, and a user can switch between the two modes.

In some embodiments, the Z-mechanism is centered at a middle null position, with springs above and below a detent pushing them back to the null position. In some embodiments, the lower spring can be optionally disengaged or uninstalled, so that the Z is at the bottom of its travel at rest. This means that any lift of the Z mechanism will trigger a throttle command, more typical of an FPV or racing drone.

In some embodiments, movement in Z (up/down) is along the long axis of the first control member (e.g., a joystick), with pulling up causing ascent and pushing down to descend. The spring pushing up could be disengaged or simply not present, allowing for the pilot to fly with a single hand (FPV or as a camera drone).

In some embodiments, the first control member is a 3-axis joystick, and the throttle is a function of squeezing the joystick. The joystick includes sensors such as springs or a load cell to sense the strength of compression, so that the harder the compression against the joystick, the larger the rate command to ascend. In some embodiments, squeezing at the top of the joystick would cause ascent, neutral would be hover, and squeeze below the center of the joystick would proportionately command descent.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of the present technology may be implemented using hardware, firmware, software or a combination thereof. When implemented in firmware and/or software, the firmware and/or software code can be executed on any suitable processor or collection of logic components, whether provided in a single device or distributed among multiple devices.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The terms “substantially,” “approximately,” and “about” used throughout this Specification and the claims generally mean plus or minus 10% of the value stated, e.g., about 100 would include 90 to 110.

As used herein in the specification and in the claims, the terms “target” and “control target” are used interchangeably.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A gimbal assembly for a control member to independently pivot about a first axis of rotation and a second axis of rotation, the gimbal assembly comprising:
a post having a first end, a second end, and a body therebetween, the post having a null position at a predetermined angular displacement about each axis of rotation;
a first biasing member disposed around the body of the post, the first biasing member being configured to generate a first or second biasing force when the post pivots about the first or second axis; and
a cage assembly coupled to the first end of the post, the cage assembly including:
a coupling member;
a first cage member having a first surface with an opening, the first surface having a downward slope towards the perimeter of the opening, wherein the coupling member is disposed between the first biasing member and the first cage member and configured to be moved up or down the slope as the post pivots;
a second cage member having a first slot elongated along the first axis, pivotal movement of the post about the second axis causing the first end of the post to translate along the first slot; and
a third cage member having a second slot elongated along the second axis, pivotal movement of the post about the first axis causing the first end of the post to translate along the second slot, wherein the second cage member is disposed between the first cage member and the third cage member.

2. The gimbal assembly of claim 1, further comprising a second biasing member disposed around the second end of the post and along a third axis of rotation, the second biasing member being configured to generate a third biasing force when the control member rotates about the third axis.

3. The gimbal assembly of claim 2, wherein the first axis, the second axis, and the third axis are orthogonal to each other.

4. The gimbal assembly of claim 1, wherein the slope has an angle of at least about 5 degrees.

5. The gimbal assembly of claim 1, wherein the second cage member is snap-fitted to the first cage member.

6. The gimbal assembly of claim 1, wherein the third cage member is snap-fitted to the first cage member.

7. The gimbal assembly of claim 1, further comprising a stopping member disposed on an interior surface of the control member and configured to prevent the control member from rotating more than 20 degrees about the third axis in either direction.

8. The gimbal assembly of claim 1, wherein the first cage member includes a first flange and a first sensor disposed thereon, the first sensor being configured to measure the pivotal movement of the post about the first axis.

9. The gimbal assembly of claim 1, wherein the first cage member includes a second flange and a second sensor disposed thereon, the second sensor being configured to measure the pivotal movement of the post about the second axis.

10. The gimbal assembly of claim 1, further comprising a third sensor disposed on the second end of the post and configured to measure the rotation of the control member about the third axis.

11. The gimbal assembly of claim 8, wherein the first, second, or third sensor is a potentiometer, a Hall effect sensor, an optical encoder, or a load cell.

12. The gimbal assembly of claim 1, wherein when the angular position of the post with respect to the first surface of the first cage member about the first axis is in a first predetermined null position, the first biasing force generates haptic feedback when the post leaves and returns to the first null position.

13. The gimbal assembly of claim 1, wherein when the angular position of the post with respect to the first surface of the first cage member about the second axis is in a second predetermined null position, the second biasing force generates haptic feedback when the post leaves and returns to the second null position.

14. The gimbal assembly of claim 2, wherein the third biasing force generates haptic feedback when the control member leaves and returns to a third null position.

15. The gimbal assembly of claim 12, wherein the first surface of the first cage member includes a plurality of surface features configured to provide tactile feedback when the post leaves the first null position and rotates about the third axis.

16. The gimbal assembly of claim 2, wherein the post includes a central bore extending along the third axis, thereby permitting a conductor cable assembly to pass through the central bore.

17. The gimbal assembly of claim 16, wherein the first, second, and/or third sensor is electrically coupled to a printed circuit board.

18. The gimbal assembly of claim 16, wherein the conductor cable assembly is coupled to the printed circuit board and configured to transmit information from the first, second, and/or third sensor to a processor.

19. The gimbal assembly of claim 2, further comprising a detent disposed on an interior surface of the control member and configured to provide haptic feedback when the control member leaves and returns to a third null position.

20. A controller for controlling a target, the controller comprising:
a first control member configured to be gripped by a hand of a user;
a base; and
a gimbal assembly of claim 1 coupled to the first control member and the base to permit movement of the first control member by the user relative to the base independently about the first axis, the second axis, and the third axis to generate a corresponding set of three independent control inputs, wherein the post of the gimbal assembly is connected to the base at the first end and with the first control member at the second end.

21. The controller of claim 20, wherein the first control member is connected to the post for relative rotational movement about the third axis.

22. The controller of claim 20, wherein the set of three independent control inputs includes a pitch movement signal, a roll movement signal, and a yaw movement signal.

23. The controller of claim 20, further comprising a second control member disposed on the first control member and configured to rotate up and down in a single degree of freedom relative to the first control member to provide in response thereto a corresponding fourth control input.

24. The controller of claim 23, wherein the fourth control input is configured to control vertical movement of the target.

25. The controller of claim 23, wherein the second control member is coupled to a detent configured to define a fourth predetermined null position, the fourth null position being hovering.

26. The controller of claim 20, wherein at least one of the first control member and the second control member is spring-centered and configured to be pushed down and pulled up by the user to control vertical movement of the target.

27. The controller of claim 20, further comprising a third control member disposed on the first control member and configured to control a camera of the target.

28. The controller of claim 20, further comprising a fourth control member disposed on the base and configured to control a camera of the target.

29. The controller of claim 20, further comprising a processor for receiving from a sensor a measured amount of displacement of the first control member about the first axis, the second axis, or the third axis.

30. The controller of claim 20, wherein the target is a fixed-wing aircraft, an electric, hybrid, and/or combustion powered aircraft, a remotely operated vehicle (ROV), a crewed aerial vehicle with distributed electric propulsion, a crewed submersible, a spacecraft, a robotic surgical device, an industrial robotic system, a computer gaming environment, an augmented or virtual reality environment or a virtual craft.
